(19) United States
(12) Patent Application Publication
(10) Pub. No.: US 2002/0035566 A1
(43) Pub. Date: Mar. 21, 2002

(54) Method and system for the wireless delivery of images

(75) Inventors: Brian Curtis Rugg, Marietta, GA (US); Christopher Donald McGarty, Atlanta, GA (US); John David Matson, Atlanta, GA (US)

Correspondence Address: Finnegan, Henderson, Farabow,, Garrett & Dunner, L.L.P., 1300 I Street, N.W., Washington, DC, 20005-3315, US

(73) Assignee: ChoicePoint, Inc.

(21) Appl. No.: 09/938,565

(22) Filed: Aug. 27, 2001

Related U.S. Application Data
(60) Provisional application No. 60/234,011, filed on Sep. 20, 2000.

(51) Int. Cl. G06F 7/00

(52) U.S. Cl. 707/100; 707/104.1

(57) ABSTRACT

A system and method are provided for sending graphical images through networks to an end-use-device. Image data along with image details is sent from a user computer to an end-use-device designated by recipient end-use-device data. The present invention comprises a user computer operated by a user, a first server, a second server and an end-use-device operated by an end-use-device user. The first server comprises a first server front end which provides an interface via a wireline network between the user computer and the first server. One function of the second server is to provide an interface between a wireless network and the second server. The invention also provides software in the end-use-device for converting data received over the wireless network to a format usable by the end-use-device.

### RELATED APPLICATION

Under provisions of 35 U.S.C. § 119(e), the Applicants claim the benefit of U.S. provisional application No. 60/234,011, filed Sep. 20, 2000, which is incorporated herein by reference.

### TECHNICAL FIELD

The present invention relates generally to systems and methods for the wireless delivery of images. More particularly, the present invention relates to systems and methods, including software, for sending graphical images through a network, such as the Internet, to an end-use-device, such as a pager or PDA device. The invention also relates to software in the end-use-device for converting the data received to a format usable by the end-use-device.

### BACKGROUND OF THE INVENTION

The need to quickly and efficiently communicate an image to a remote individual has become a common need for many organizations as well as individuals today. For example, a law enforcement entity may wish to send a photographic image of a suspected criminal to another law enforcement entity or a law enforcement officer in the field. One plausible way at present for accomplishing this task, is to digitize the desired image into an image file, attach the image to an e-mail and send the e-mail along with the image file to the recipient. Perhaps another way to transmit the image is to photocopy the photograph and fax the image between the law enforcement entities.

With the ultimate goal of getting the image to the law enforcement officers in the field, present technologies requiring undesirably large bulky desktop equipment may require the officer to leave the field in order to receive the image. Requiring the officer to leave the field to obtain image data consumes time and uses the officer's time to complete tasks, which are not at the core of the law enforcement function. Thus, sending of an image to an officer in the field becomes a time-consuming and laborious task.

One approach to the problem is described in U.S. Pat. No. 6,101,548 to Okada. In this patent, a communications terminal device such as a facsimile device is employed with a function of transmitting original document image data to a destination by electronic mail. Before image data transmission to a destination by electronic mail, a main controller of the facsimile device converts the image data on one page of the original document to electronic mail data and determines how much volume the image data has. The image data on one page of the original document is transmitted to a destination by a single electronic mail when the calculation result does not exceed a prescribed volume. On the other hand, the original image on one page of the original document is divided up into smaller pieces of data and transmitted to a destination by a plurality of electronic mails respectively when the calculation result exceeds a prescribed volume.

Another approach to the problem is described in U.S. Pat. No. 6,076,109 to Kikinis. In this patent, a system is provided wherein relatively low-end computers, such as portable, battery-powered computers ordinarily incapable of sophisticated Internet browsing functions, may be used to browse the Internet. The enhanced computing ability for such portables is provided by a unique Internet server adapted for transposing data files to alternative, low information-density form, preferably comprising simplified or single files suitable for rapid processing and display by connected portable and other low-end computers. In embodiments wherein battery-powered field units are used, battery life is exhibited far beyond what would be expected for a battery-powered computer with computing power for browsing the Internet directly. In some embodiments of the invention, adapted files are saved and identified for future use in communicating with specific devices over Internet connections.

Neither of the aforementioned patents disclose reconstruction by a portable end-use device of multiple e-mail files containing an image. Also, neither disclose the conversion of the image data by a portable end-use-device into a format displayable by the end-use-device. And finally, none of the aforementioned patents disclose converting the image to text data, breaking the text data into separate e-mail messages based upon the maximum e-mail size receivable by the end-use-device, and sending the image to the end-use-device over two separate paths.

Therefore, there remains a need in the art for a fast, simple, and flexible way to transmit images to remote individuals who do not have access to conventional desktop equipment. There is also a need in the art for receipt of image data using available remote devices such as pagers and the like.

### SUMMARY OF THE INVENTION

In accordance with the current invention, a wireless image delivery system and method are provided that avoid the problems associated with prior art delivery systems as discussed herein above.

In one aspect, a method for transmitting an image consistent with the invention includes receiving image data in a first file format at a first server. Once the image data is received, the method also includes converting the image data to a plurality of image files in a second file format with each one of the plurality of image files limited to a specified file size. And finally, the method includes transferring the plurality of image files to a second server over a first path and then sending the plurality of image files from the second server to an end-use-device over a second path. The end-use-device is not capable of receiving files over the first path and is limited to receiving files of a size less than or equal to the specified size.

In another aspect, a method for transmitting an image consistent with the invention includes converting at a user computer the image data in a first file format to a plurality of image files in a second file format. Each one of the plurality of image files is limited to a specified file size. Next the method includes transferring the plurality of image files to a second server over a first path and then sending the plurality of image files from the second server to an end-use-device over a second path. The end-use-device is not capable of receiving files over the first path and is limited to receiving files of a size less than or equal to the specified size.

In yet another aspect, a system for transmitting an image consistent with the invention includes a first server configured to receive image data in a first file format and convert the image data to a plurality of image files in a second file format. Each one of the plurality of image files is limited to a specified file size. The system also includes a second server in communications with the first server via a first path. This second server is configured to receive the plurality of image files over a first path and to send the plurality of image files from the second server over a second path.

In yet another aspect, a system for transmitting an image consistent with the invention includes a user computer configured to convert image data in a first file format to a plurality of image files in a second file format. Each one of the plurality of image files is limited to a specified file size. The system also includes a second server in communications with the user computer via a first path. The second server is configured to receive the plurality of image files over a first path and to send the plurality of image files from the second server over a second path.

It is to be understood that both the foregoing general description and the following detailed description are exemplary and explanatory only and are intended to provide further explanation of the invention as claimed. The following description, as well as the practice of the invention, set forth and suggest additional advantages and purposes of the invention.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a functional block diagram of a system in an exemplary operating environment for an exemplary embodiment of the invention;

FIG. 2 is a flow chart that illustrates the general operation of an exemplary embodiment of the present invention;

FIG. 3A is a flow chart that illustrates the user uploading the image file, image details and recipient end-use-device data to the first server via a web page;

FIG. 3B is a flow chart that illustrates the user uploading the image file, image details and recipient end-use-device data to the first server via e-mail;

FIG. 4 is a flow chart that illustrates the first server converting and breaking the data into blocks, and then sending the blocks as parts of multiple e-mails to the second server;

FIG. 5 is a flow chart that illustrates the second server sending the multiple e-mails to the end-use-device over the wireless network;

FIG. 6 is a flow chart that illustrates the end-use-device converting the e-mails into the image and displaying the image;

FIG. 7 is a screen shot illustrating the image delivery start page;

FIG. 8 is a screen shot illustrating the login window of the image delivery start page;

FIG. 9 is a screen shot illustrating the image entry page;

FIG. 10 is a screen shot illustrating the e-mail message containing the data from the image entry page;

FIG. 11 is a screen shot illustrating the details text file containing the data from the image entry page;

FIG. 12 is a screen shot illustrating the raw UUencoded file containing the data from the image entry page UUencoded;

FIG. 13 is a screen shot illustrating the modified UUencoded file containing the data from the image entry page UUencoded;

FIG. 14 is a screen shot illustrating the Motorola PAGEWRITER 2000X utilized in the exemplary embodiment of the present invention;

FIG. 15 is a screen shot of the Motorola PAGEWRITER 2000X illustrating the incoming image received prompt;

FIG. 16 is a screen shot of the Motorola PAGEWRITER 2000X illustrating the percentage of the image left to reconstruct;

FIG. 17 is a screen shot of the Motorola PAGEWRITER 2000X illustrating display image received prompt;

FIG. 18 is a functional block diagram of a system in an exemplary operating environment for an alternative embodiment of the invention;

FIG. 19 is a flow chart that illustrates the general operation of an alternative embodiment of the present invention;

FIG. 20 is a flow chart that illustrates the receiving of e-mail messages by the second server and sending of the emails to the end-use-device; and

FIG. 21 is a flow chart that illustrates the receiving of e-mail messages by the end-use-device, converting them and then displaying them.

### DETAILED DESCRIPTION OF THE PREFERRED EMBODIMENTS

Reference will now be made to various embodiments according to this invention, examples of which are shown in the accompanying drawings and will be obvious from the description of the invention. In the drawings, the same reference numbers represent the same or similar elements in the different drawings whenever possible.

Broadly stated, the invention is a system and method, including software, for sending graphical images through a network, such as the Internet, to an end-use-device, such as a pager or PDA device. The invention also provides software in the end-use-device for converting the data received to a format usable by the end-use-device.

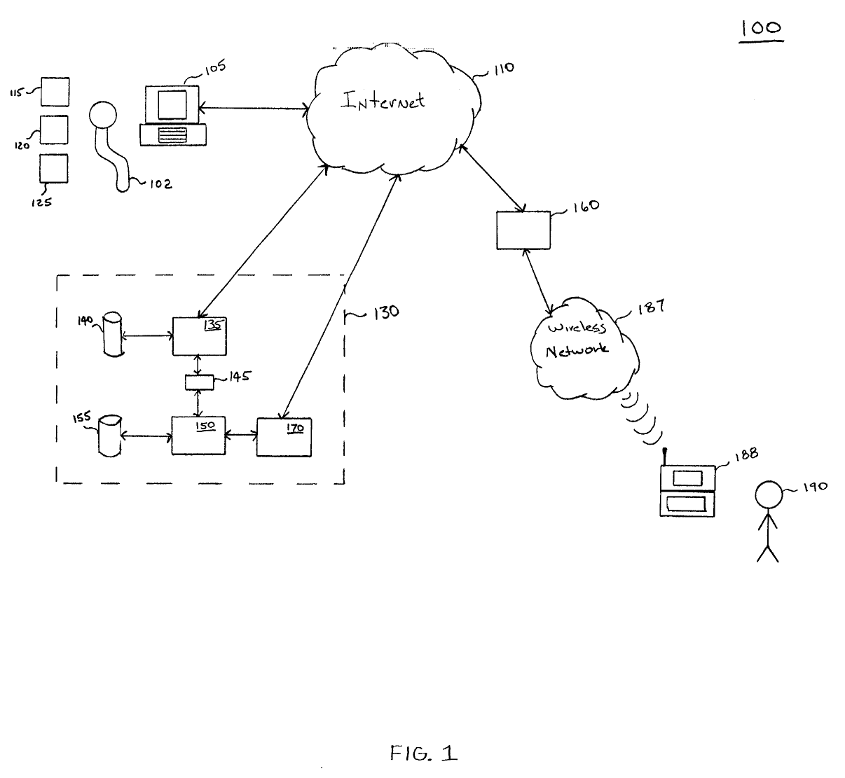

Referring to FIG. 1, an embodiment of the present invention provides for the sending of image data 115 along with image details 120 from a user computer 105 to an end-use-device 188 designated by recipient end-use-device data 125. The embodiment of present invention comprises the user computer 105 operated by a user 102, a first server 130, a second server 160 and the end-use-device 188 operated by an end-use-device user 190. The first server 130 comprises a first server front end 135 with its associated first server front end database 140, a first server back end 150 with its associated first server back end database 155, and an SMTP server 170. The first server front end 135 is separated from the first server back end 150 by a first server firewall 145. The function of the first server front end 135 is to provide a web interface via the Internet 110 between the user computer 105 and the first server 130. The function of the SMTP server 170 is to provide an e-mail interface via the Internet 110 between the user computer 105 and the first server 130. The function of the second server 160 is to provide an interface to the wireless network 187.

The first server front end 135 is preferably implemented on a Compaq Proliant 1600 server running Windows 2000 and Domino Webserver. The first Server back end 150 is preferably implemented on a Compaq Proliant 1600 server running NT4 and Domino Application Server. And the SMTP server 170 is preferably implemented on a Compaq DL 360 running Windows 2000 and Domino SMTP Mail Server.

An example operation of the invention is the situation in which a law enforcement agency wishes to send an officer a pictorial image of a particular individual suspected of a crime. In this case, the image along with the address of the officer's pager would be uploaded from the law enforcement agency to a secured Internet server. At the server, the image data is converted to an ASCII format, placed in the body of an e-mail or e-mails and sent to a server operated by a wireless network provider. From the server operated by the wireless network provider, the e-mail or e-mails are sent to the officer's pager over a wireless network.

The officer's pager receives the e-mail, converts the data to a displayable format and then displays the image onto the screen of the pager. Software located on the pager must receive the e-mail, determine that the body contains image data, and convert the image data from the ASCII format to the displayable format used by the pager. Also, if the image is large, it may become necessary to receive the data for one image in two or more separate e-mail bodies. In this case the software must be able to merge the data from the e-mails received into one image.

Overview of the Preferred Method

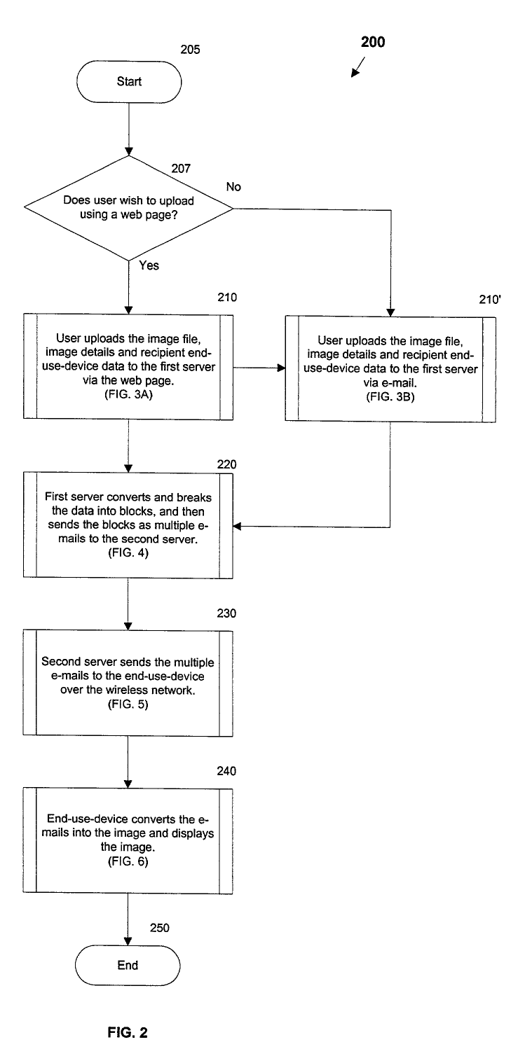

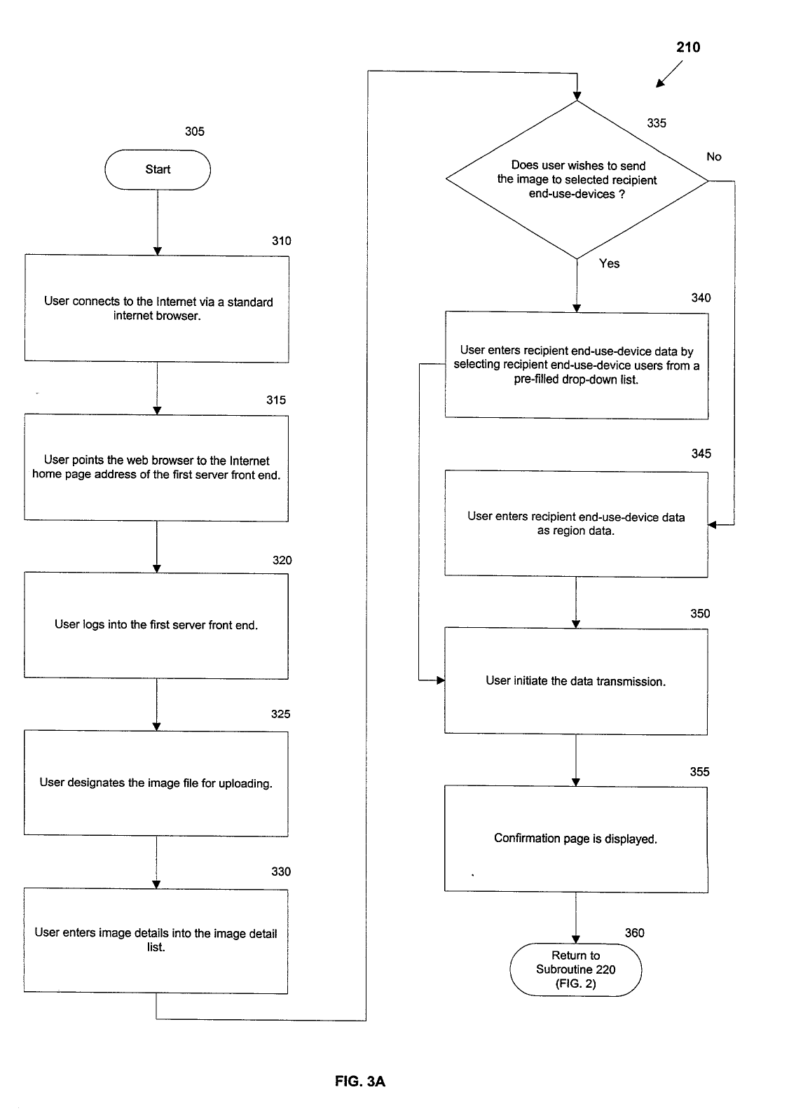

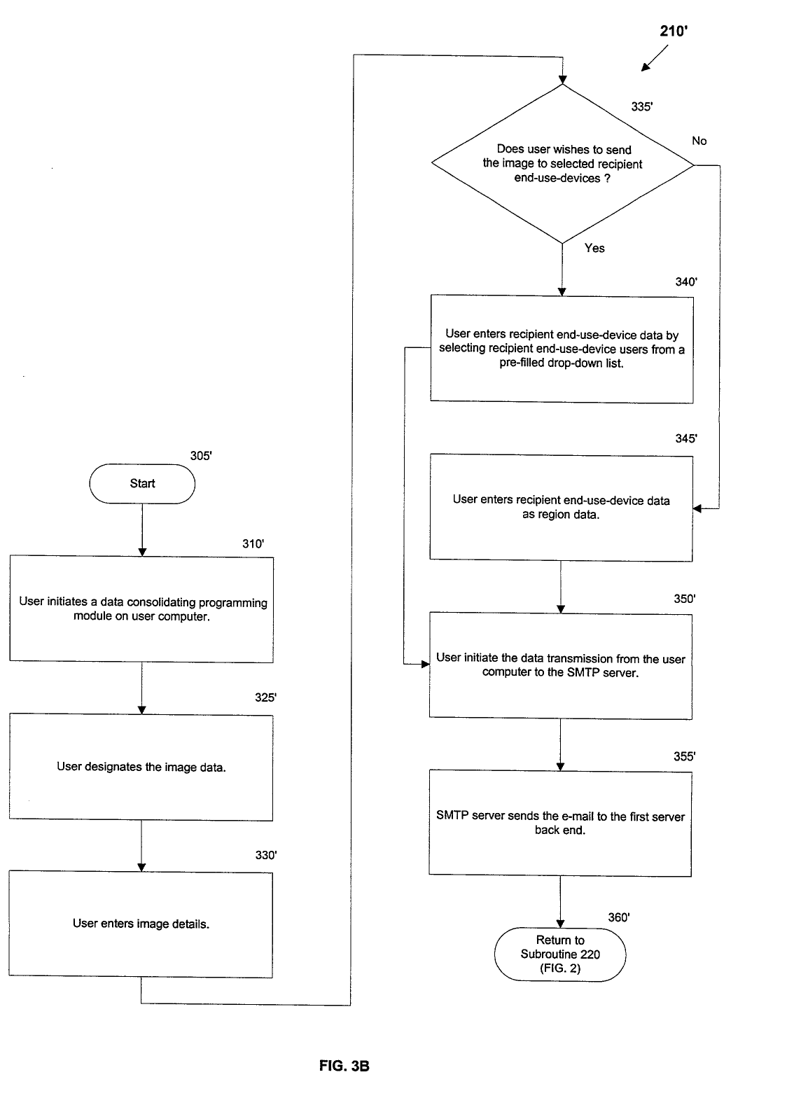

FIG. 2 is a flow chart setting forth the general steps involved in an exemplary method 200 for the wireless delivery of an image. The implementation of the steps of method 200 in accordance with an exemplary embodiment of the present invention will be described in greater detail in FIG. 3A through FIG. 6.

Exemplary method 200 begins at starting block 205 and proceeds to decision block 207 where it is determined if the user 102 wants to upload using a web page. If it is determined at decision block 207 that the user 102 wants to upload using a web page, method 200 advances to subroutine 210 where the user 102 uploads the image data 115, image details 120 and recipient end-use-device data 125 to the first server 130 via a web page. The steps comprising subroutine 210 are shown in FIG. 3A and will be described in greater detail below. If it is determined at decision block 207, however, that the user 102 does not want to upload using a web page, method 200 advances to subroutine 210′ where the user 102 uploads the image data 115, image details 120 and recipient end-use-device data 125 to the first server 130 via a e-mail. The steps comprising subroutine 210′ are shown in FIG. 3B and will be described in greater detail below.

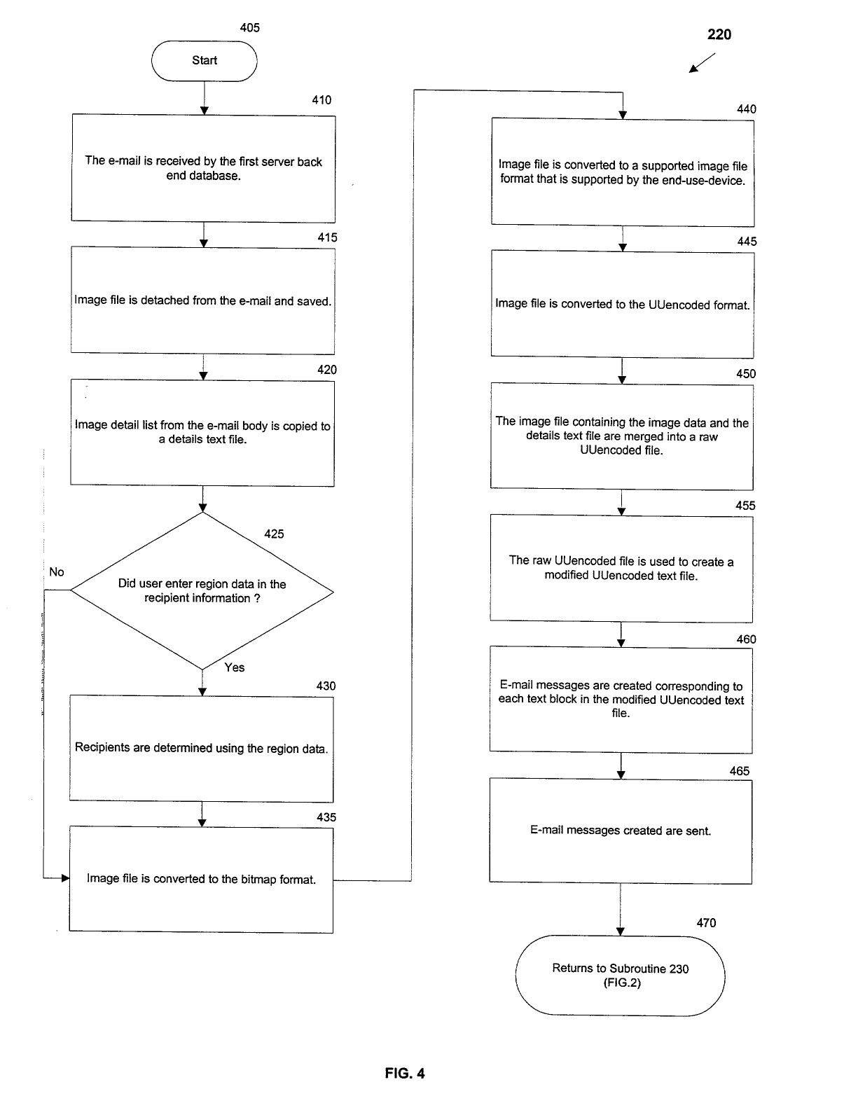

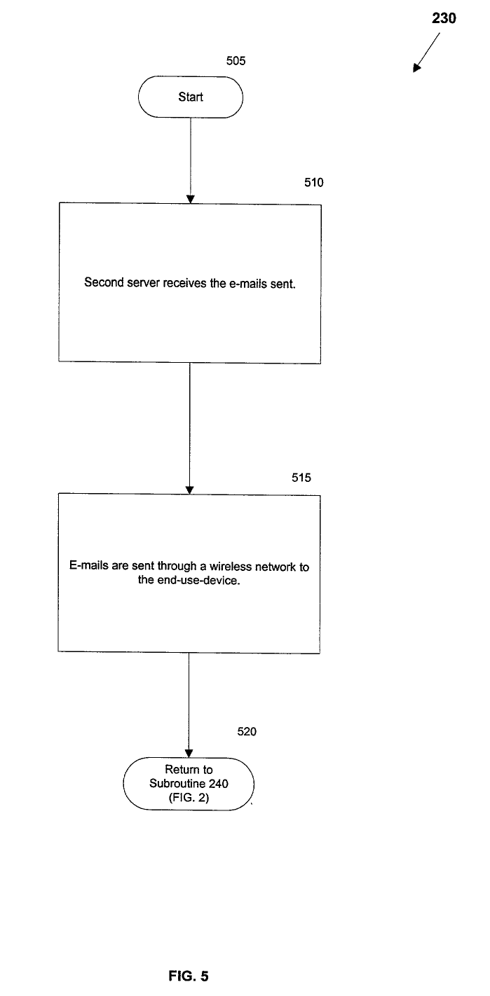

Next, the method proceeds to subroutine 220 where the first server 130 converts and breaks the data into blocks, and then sends the blocks as multiple e-mails to the second server 160. The steps of subroutine 220 are shown in FIG. 4 and will be described in greater detail below. The method continues to subroutine 230 where the second server 160 sends the multiple e-mails to the end-use-device 188 over the wireless network 187. The steps of subroutine 230 are shown in FIG. 5 and will be described in greater detail below.

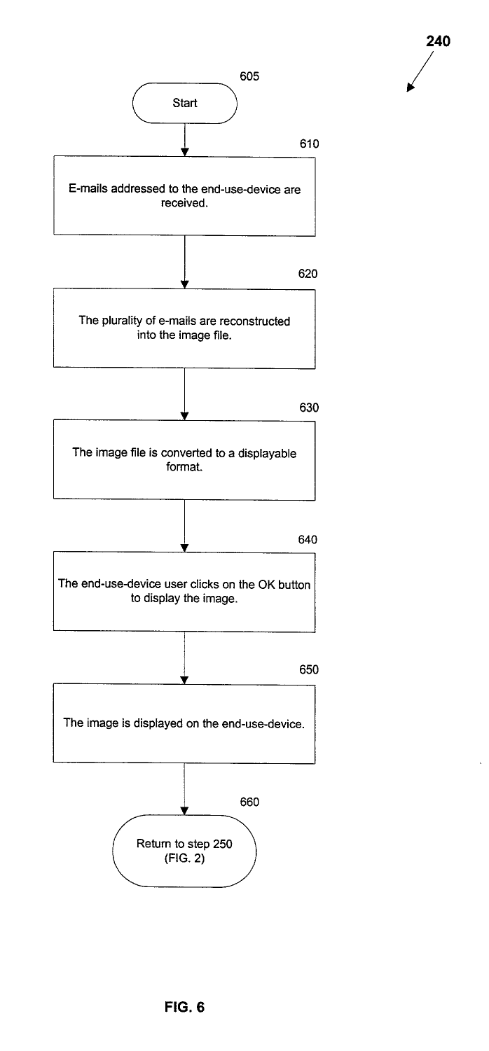

Exemplary method 200 continues to subroutine 240, where the end-use-device 188 converts the e-mails into the image and displays the image. The steps of subroutine 240 are shown in FIG. 6 and will be described in greater detail below. From subroutine 240, exemplary method 200 ends at step 250.

Image and Data Uploaded to the First Server Via a Web Page

Turning now to FIG. 3, describing the exemplary subroutine 210 from FIG. 2 in which the user 102 uploads the image data 115, image details 120 and recipient end-use-device data 125 to the first server 130. Subroutine 210 begins at starting block 305 and advances to step 310 where the user 102 connects to the Internet 110 via a standard internet browser.

Preferred methods of the present invention utilize a user computer 105, which is typically a personal computer or other similar microcomputer-based workstation. However, those skilled in the art will appreciate that user computer 105 may comprise any type of computer operating environment such as hand-held devices, multiprocessor systems, microprocessor-based or programmable consumer electronics, minicomputers, mainframe computers, and the like. User computer 105 may also be practiced in distributed computing environments where tasks are performed by remote processing devices. User computer 105 has the capability of connecting to the Internet 110, generally through the use of a standard web browser type software package such as Microsoft Corporation's INTERNET EXPLORER™ or Netscape Communication Corporation's NAVIGATOR™ or COMMUNICATOR™ Internet browser computer programs. The user 102 typically connects the user computer 105 to the Internet 110 through an Internet service provider (ISP) (not shown), in the manner as is known to those skilled in the art.

Once the user 102 has connected to the Internet 110 through the user computer 105 in step 310, subroutine 210 continues to step 315 where the user 102 points the web browser to the Internet home page address or Uniform Resource Locator (URL) of the first server front end 135. The first server front end 135 is associated with the first server 130 constructed in accordance with the invention. The function of the first server front end 135 is to provide an Internet interface between the user computer 105 and the first server 130. As will be known to those skilled in the art, a “web front end” is a computer system that receives hypertext transfer protocol (http) requests from a web browser computer program directed to a specific URL, and provides responses to the requesting computer system that, when processed by the web browser computer program, displays a page of the Internet web site associated with the URL. For example, an exemplary URL employed for the present invention at the time of filing this patent application is “http://www.choicepoint.net/polly”. Directing an Internet-connected computer system with an operative Internet web browser program at this URL causes display of the home page associated with this web site on the computer's display. Such operations are well known to those skilled in the art and will not be discussed further herein.

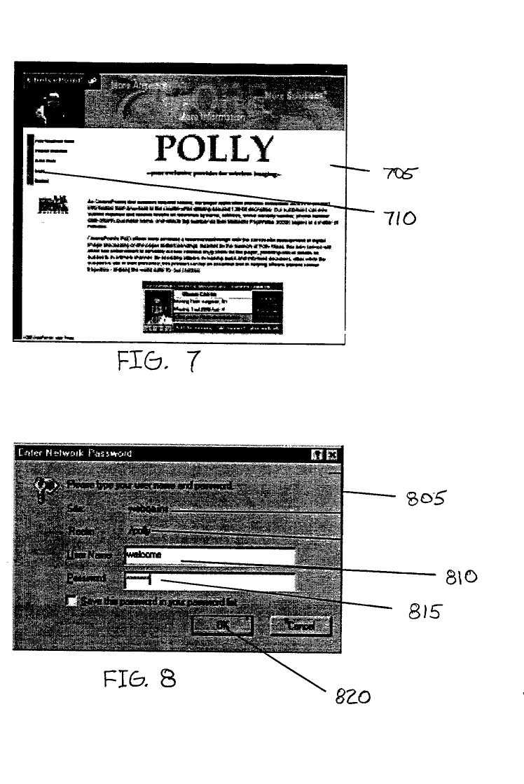

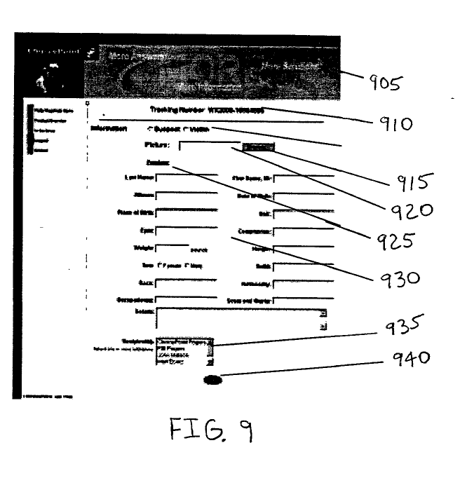

Once the user 102 points the web browser to the Internet home page address of the image delivery start page 705 at www.choicepoint.net/polly as shown in FIG. 7, the subroutine 210 advances to step 320 where the user 102 logs into the first server front end 135. To initiate the login process, the user 102 clicks the login button 710 of FIG. 7. Once the login button 710 is clicked, the login window 805 as shown in FIG. 8 appears. At the login window 805 the user enters a unique username 810, password 815, and clicks the “OK” button 820 in order to obtain access to the image entry page 905 as shown in FIG. 9.

After the user 102 logs into the first server front end 135 in step 320, subroutine 210 advances to step 325 where the user 102 designates the image data 115 for uploading. Each image entry page 905 as shown in FIG. 9 is labeled with a unique tracking id 910 to be used throughout the process. The site is preferably coded in hyper text mark-up language (HTML) and uses a Secure Sockets Layer (SSL) certificate for added protection and encryption during request transmission. Secure Sockets Layer (SSL) is a conventional security protocol on the Internet. When an SSL session is started, the server sends its public key to the browser, which the browser uses to send a randomly-generated private key back to the server in order to have a private key exchange for that session. Developed by Netscape Corporation, SSL has been merged with other protocols and authentication methods. SSL utilizes the public keys and private keys of the Public Key Cryptography method. Those skilled in the art will appreciate that Public Key Cryptography is a known method that uses a two-part key (code) that is made up of public and private components. To encrypt messages, the published public keys of the recipients are used. To decrypt the messages, the recipients use their unpublished private keys known only to them.

Still referring to FIG. 9, the image entry page 905 resides on the first server front end 135 existing outside of the first server firewall 145. A firewall is generally a method for keeping a network secure. It can be implemented in a single router that filters out unwanted packets, or it may use a combination of technologies in routers and hosts. Firewalls are widely used to give users access to the Internet in a secure fashion as well as to separate a company's public Web server from its internal network. They are also used to keep internal network segments secure.

At this step, user 102 designates the image data 115 for uploading using the browse button 915 on the image entry page 905. The file name of the image will appear in the image upload field 920. The image data 115 can be in a variety of different file formats. For example, such formats and corresponding file extensions can comprise one of the following: tagged image file format (.tif), graphics interchange format (.gif), joint photographic experts group format (.jpg), and bit map format (.bmp) However, embodiments of the present invention envision that any other file format for graphic images will suffice. The user 102 is able to preview the image corresponding to the image data 115 by clicking the preview button 925. If the user 102 clicks the preview button 925, the image is displayed with a height of 115 pixels. Once the image is displayed, the user 102 can remove and replace it as needed.

From step 325, subroutine 210 advances to step 330 where the user 102 enters image details 120 into the image detail list 930 comprising designated fields on the image entry page 905 as shown in FIG. 9. Image details 120 in the present embodiment may include: suspect or victim, first name, last name, date of birth, hair color, place of birth, eye color, height, complexion, weight, sex, build, race, occupation(s), nationality, scars and marks, and comments. Those skilled in the art will appreciate that other details may accompany an image.

Many of these fields have drop-down selection lists with standard values while others are free-form text fields. For example, if the user 102 clicks on the hair color field, a list of various hair colors will appear. The user 102 need only click on the desired color to enter the data rather than typing a word into the field. If the desired color is not included in the drop-down list, the user 102 may enter the color by typing a word into the field. The user 102 optionally completes all fields in the image detail list 930.

Once the user 102 enters image details 120 in step 330, subroutine 210 advances from step 330 to decision block 335. At decision block 335 it is determined if the user 102 wishes to send the image to selected recipient end-use-devices. If the user 102 wishes to send to selected recipient end-use-devices, subroutine 210 advances to step 340 where the user 102 enters recipient end-use-device data 125. This is done by selecting recipient end-use-device users from a pre-filled drop-down list 935 as shown in FIG. 9. In this list, only the names of end-use-device users associated with the specific username 810 entered on the login window 805 as shown in FIG. 8 will appear. The user 102 may select multiple individual end-use-devices from this list. A list of all end-use-device users and their respective end-use-device numbers are stored in the first server front end database 140 on the first server front end 135 external to the first server firewall 145. In order to update the first server front end database 140, replication between it and the identical internal first server back end database 155 located on the first server back end 150 within the first server firewall 145 typically occurs. Therefore, new end-use-device users subsequently added to the first server back end database 155 and will preferably not become active until it is replicated into the first server front end 135. From step 340, subroutine 210 advances to step 350.

If at decision block 335 it was determined, however, that the user 102 does not wish to send the image to selected recipient end-use-devices, subroutine 210 advances to step 345. At step 345 the user 102 enters recipient end-use-device data 125 as region data including the city and state of the broadcast as well as a radius from the city center establishing the broadcast limit. From step 345, subroutine 210 advances to step 350.

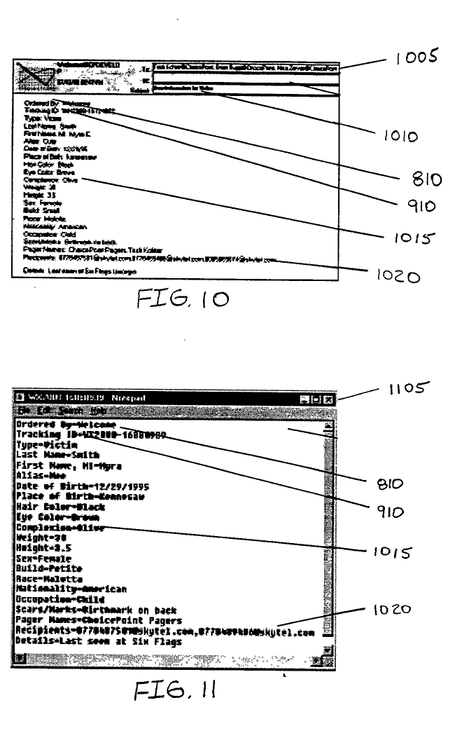

At step 350 of subroutine 210, the user 102 initiate the data transmission by clicking the submit button 940 of FIG. 9. Clicking the submit button 940 triggers a temporary record save to the first server front end database 140 on the first server front end 135. Data included in this temporary record save includes the image data 115, the image details 120, and recipient end-use-device data 125. After the temporary record save to the first server front end database 140 located on the first server front end 135 is completed, an e-mail 1005 as shown in FIG. 10 is sent to the first server back end database 155 located on the first server back end 150. The e-mail 1005 contains a subject line 1010 containing, for example, “New Information for Victim” or “New Information for Suspect” according to the particular case type selected in the image detail list 930. The data from the detail list 930 is placed in the body of the e-mail 1005 as image detail list 1015 of FIG. 10. The image data 115 is sent with the e-mail 1005 as an attachment. The recipient information 1020 containing the recipient end-use-device data 125, username 810, and tracking ID 910 are also listed in the body of the e-mail 1005.

After the user 102 clicks the submit button 940 in step 350, the subroutine advances to step 355 where a confirmation page is displayed after the temporary record has been successfully saved to the first server front end database 140. This does not verify that the e-mail 1005 to the internal server has been sent successfully. The aforementioned image data 115, the image details 120, and recipient end-use-device data 125 preferably will remain in the first server front end database 140 until an e-mail 1005 transmission confirmation has been returned to the first server front end 135. From step 355 subroutine 210 continues to step 360 and returns to subroutine 220, of FIG. 2.

Image and Data Uploaded to the First Server Via E-mail

Turning now to FIG. 3B, describing the exemplary subroutine 210′ from FIG. 2 in which the user 102 uploads the image data 115, image details 120 and recipient end-use-device data 125 to the first server 130 via e-mail. Subroutine 210′ begins at starting block 305′ and advances to step 310′ where the user 102 initiates a data consolidating programming module on user computer 105. This programming module, through user input, creates the e-mail 1005. Unlike subroutine 210, subroutine 210′ provides for the creation of the e-mail 1005 through the use of the data consolidating programming module executed on user computer 105 and not through the use of a web page.

After the user 102 initiates the data consolidating programming module on user computer 105 in step 310′, subroutine 210′ advances to step 325′ where the user 102 designates the image data 115. The image data 115 can be in a variety of different file formats. For example, such formats and corresponding file extensions can comprise one of the following: tagged image file format (.tif), graphics interchange format (.gif), joint photographic experts group format (.jpg), and bit map format (.bmp). However, embodiments of the present invention envision that any other file format for graphic images will suffice.

From step 325′, subroutine 210′ advances to step 330′ where the user 102 enters image details 120. Again, image details 120 in the present embodiment may include: suspect or victim, first name, last name, date of birth, hair color, place of birth, eye color, height, complexion, weight, sex, build, race, occupation(s), nationality, scars and marks, and comments. Those skilled in the art will appreciate that other details may accompany an image. The data consolidating programming module may use fields that have drop-down selection lists with standard values while others are free-form text fields. For example, if the user 102 clicks on the hair color field, a list of various hair colors will appear. The user 102 need only click on the desired color to enter the data rather than typing a word into the field. If the desired color is not included in the drop-down list, the user 102 may enter the color by typing a word into the field.

Once the user 102 enters image details 120 in step 330′, subroutine 210′ advances from step 330′ to decision block 335′. At decision block 335′ it is determined if the user 102 wishes to send the image to selected recipient end-use-devices. If the user 102 wishes to send to selected recipient end-use-devices, subroutine 210′ advances to step 340′ where the user 102 enters recipient end-use-device data 125. This is done by selecting recipient end-use-device users from a pre-filled drop-down list of the data consolidating programming module. The user 102 may select multiple individual end-use-devices from this list. From step 340′, subroutine 210′ advances to step 350′.

If at decision block 335′ it was determined, however, that the user 102 does not wish to send the image to selected recipient end-use-devices, subroutine 210′ advances to step 345′. At step 345′ the user 102 enters recipient end-use-device data 125 as region data including the city and state of the broadcast as well as a radius from the city center establishing the broadcast limit. From step 345′, subroutine 210′ advances to step 350′.

At step 350′ of subroutine 210′, the user 102 initiate a data transmission from the user computer 105 to the SMTP server 170 by clicking a submit button. In this transmission, the image data 115 is sent in the e-mail 1005 as an attachment. The recipient end-use-device data 125, username 810, and tracking ID 910 are listed in the body of the e-mail 1005.

After the user 102 initiate the data transmission from the user computer 105 to the SMTP server 170 in step 350′, the subroutine advances to step 355′ where the SMTP server 170 in turn sends the e-mail 1005 to the first server back end 150. The first server back end 150 then sends the e-mail 1005 to the first server back end database 155. From step 355′ subroutine 210′ continues to step 360′ and returns to subroutine 220, of FIG. 2.

First Server Converts and Sends Image and Data to Second Server

Turning now to FIG. 4, describing the exemplary subroutine 220 from FIG. 2 in which the first server 130 converts and breaks the data into blocks, the blocks are sent as multiple e-mails to the second server 160. Subroutine 220 begins at starting block 405 and advances to step 410 where the e-mail 1005 is received by the first server back end database 155. Once the e-mail 1005 is received, the subroutine advances to step 415 where the image data 115 is detached from the e-mail 1005 and saved. Detached image files are stored in the same format in which they were received and are re-named as the tracking ID 910 followed by the appropriate file extension for the format. For example, such formats and corresponding file extensions can comprise one of the following: tagged image file format (.tif), graphics interchange format (.gif), joint photographic experts group format (.jpg), and bit map format (.bmp).

From step 415, subroutine 220 advances to step 420 where the image detail list 1015 from the e-mail 1005 body is copied to a details text file 1105. The details text file 1105, as shown if FIG. 11, is typically saved in the first server back end database 155 with a name comprising the tracking ID 910 followed by “.txt”. The “.txt” extension signifies that the file is a text file. The recipient information 1020 containing the recipient end-use-device data 125, username 810, and tracking ID 910 are also copied to the details text file 1105.

Once the data is copied in step 420, subroutine 220 advances from step 420 to decision block 425. At decision block 425 it is determined if the user entered region data in the recipient information 1020. If the user did not enter region data in the recipient information 1020, subroutine 220 continues to step 435 where the image data 115 is converted to the bitmap format. If the user entered region data in the recipient information 1020, subroutine 220 continues to step 430, where recipients are determined using the region data. In order to accomplish this, the city, state, and radius are read from the details text file 1105. The city, state, and radius are used to determine the ten digit zip code corresponding to the center of the city in question. The zip code is then converted into a latitude and longitude pair, which are then used in a proximity search, along with the radius given, to find all possible geocodes within the radius. This list of geocodes is then matched to a data base containing end-use-device users and their associated city, state, geocode, and address. The addresses corresponding to the identified geographic area are then added as the recipient end-use-device data in the details text file 1105.

If the user did not enter region data in the recipient information 1020, or from step 430, subroutine 220 advances to step 435 where the image data 115 is converted to the bitmap format. At step 435 the image data 115 saved according to its tracking ID 910 is preferably converted from its original format to an 8-bit grayscale bitmap format. In addition, the image is typically resized to a height of 115 pixels or a max width of 100 pixels and saved in the bitmap format. The saved file name of the image data 115 is the tracking ID 910 followed by “.bmp” which designating the file as a bitmap formatted file.

From step 435, subroutine 220 advances to step 440 where the image data 115 is converted to a supported image file format that is supported by the end-use-device 188. For example, if a Motorola 2000x pager supplied by Motorola, Inc., of Schaumburg, Ill. is utilized as the end-use-device 188, the “.rob” format may be used. The “.rob” format is a proprietary file format of Motorola, Inc. and is currently the only image format that is supported by the Motorola 2000x pager. In this case, image data 115 is converted from the bitmap format to the “.rob” format using an executable file supplied by Motorola, Inc. Once converted, the image data 115 is saved in the first server back end data base 155 with a “.rob” extension. The file name is the tracking ID 910 followed by “.rob”.

From step 440, subroutine 220 advances to step 445 where the image data 115, now in the supported image file format, is preferably converted to the UUencoded format. The traditional UUencode headers and footers are removed from this file. UUencoding is a common method for transmitting non-text files via Internet e-mail, because the Internet was originally designed only for ASCII text. A UUencode utility encodes a file by converting 8-bit characters into 7-bit ASCII text, and a UUdecode utility decodes the file back to the original format at the receiving end. Originating in the UNIX community, UUcoding was one of the first methods for sending binary files as attached files via Internet e-mail.

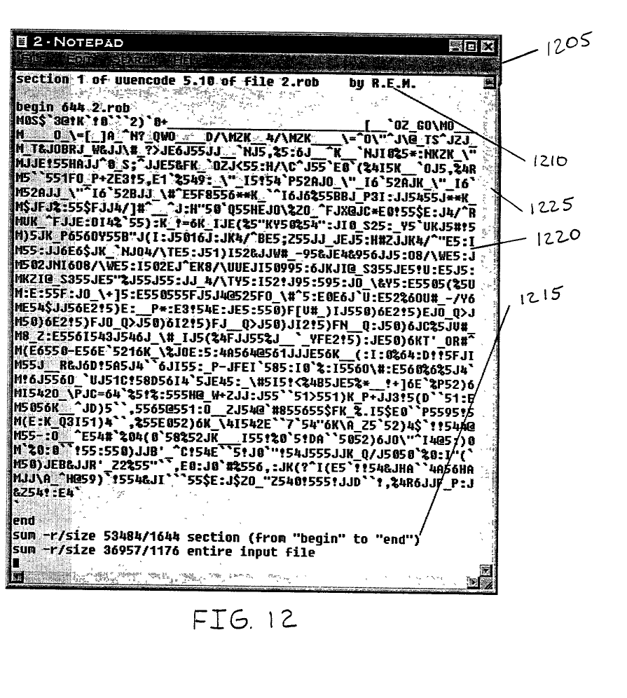

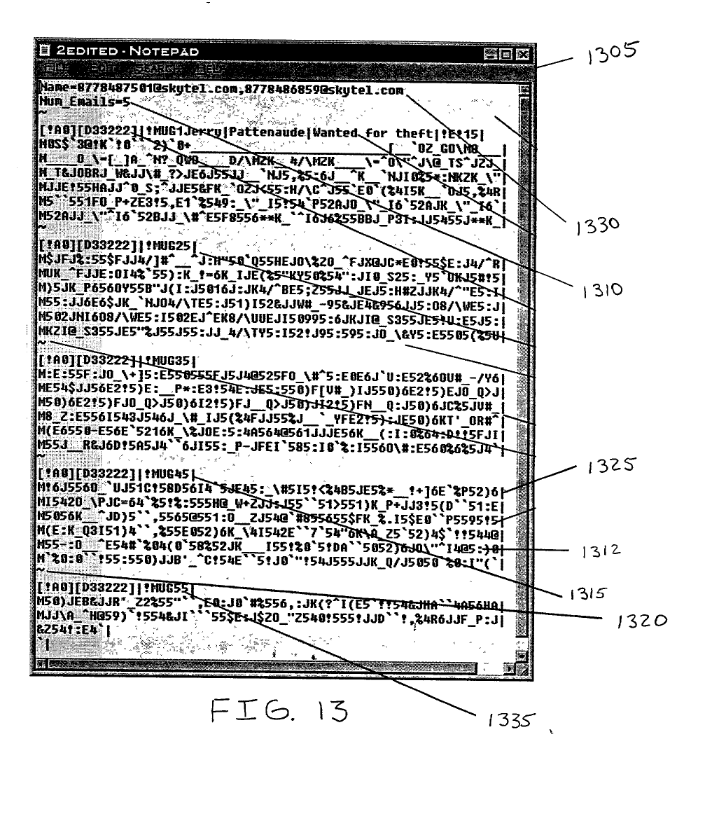

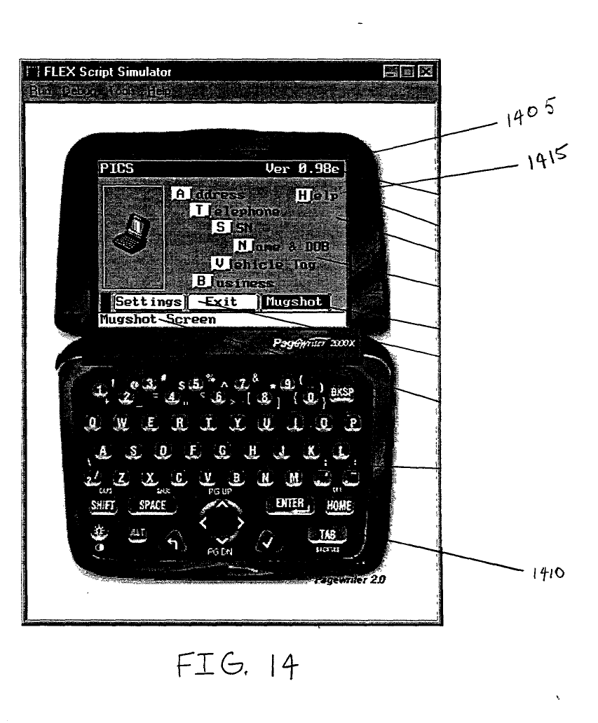

From step 445, subroutine 220 advances to step 450 where the image data 115 containing the image data and the details text file 1105 of FIG. 11 are merged into a raw UUencoded file 1205 as shown if FIG. 12. This file contains a traditional UUencoded header 1210, traditional UUencoded footer 1215, UUencoded image file data 1220, and details text file data 1225. After the raw UUencoded file 1205 is created in step 450, the subroutine continues to step 455 where the raw UUencoded file 1205 is used to create a modified UUencoded text file 1305 as shown in FIG. 13. Because the end-use-device 188 may be limited to a maximum size file it can receive, the data contained in the raw UUencoded file 1205 is divided into blocks as it is placed in the modified UUencoded text file 1305. For example, the file size limit may be 2000 characters. The total number of blocks 1310 need to be sent to the end-use-device 188 is determined and placed in the modified UUencoded text file 1305. Next at this step, the text of the raw UUencoded file 1205 is split into a plurality blocks equal to the total number of blocks 1310 determined previously. In FIG. 13, a typical block 1312 is shown. Prior to the block 1312 is the header 1315 corresponding to the block which follows a separator 1320 indicating the end of the block. Recipient list 1330 indicating the e-mail address of the recipient end-use-devices is derived from the recipient data and placed in the modified UUencoded text file 1305. Pipes are preferably added to the end of each line to ensure that no characters are cut off when the data is transmitted to the end-use-device 188. An exemplary pipe 1325 is shown in FIG. 13.

From step 455, subroutine 220 advances to step 460 where mail messages are created corresponding to each text block in the modified UUencoded text file 1305. The addresses for the each e-mail is obtained from the recipient list 1330 contained in the modified UUencoded text file 1305.

From step 460, subroutine 220 advances to step 465 where the e-mail messages created in step 460 are sent. The e-mails are sent in numerical order with a short delay between each transmission. The header of each text block determines this order. For example, in a series of five blocks, the following header tags are in numerical order: 15, 25, 35, 45, 55, wherein 15 indicates 1 of 5, 25 indicates 2 of 5, and so forth. An exemplary header tag 1335 containing 55 is shown in FIG. 13. From step 465, the subroutine continues to step 470 and returns to subroutine 230, FIG. 2.

Second Server Sends Multiple E-mails to the End-use-device

Turning now to FIG. 5, describing the exemplary subroutine 230 from FIG. 5 in which the second server 160 sends the multiple e-mails to the end-use-device 188 over the wireless network 187. Subroutine 230 begins at starting block 505 and advances to step 510 where the second server 160 receives the e-mails sent in step 465 of subroutine 220. The second server 160 is operated by a provider of wireless e-mail services. Those skilled in the art will appreciate that many wireless e-mail service providers are available.

Once the second server 160 receives the e-mails, subroutine 230 advances to step 515 where the e-mails are sent through a wireless network 187 to the end-use-device 188 corresponding to the addressee of the e-mails. In the present invention, wireless is defined as radio transmission via the airwaves. Those skilled in the art will appreciate that various other communication techniques can be used to provide wireless transmission including infrared line of sight, cellular, microwave, satellite, packet radio and spread spectrum radio. The end-use-device 188 in this case can be any mobile terminal such as a smart phone, personal digital assistant, intelligent pager, portable computer, hand held computer, or any device capable of receiving wireless data. Wireless data may include, but is not limited to, paging, text messaging, e-mail, Internet access and other specialized data applications specifically excluding voice transmission. A personal digital assistant (PDA) is a handheld computer that serves as an organizer for personal information. It generally includes at least a name and address database, to-do list and note taker. PDAs are typically pen based and use a stylus to tap selections on menus and to enter printed characters. The unit may also include a small on-screen keyboard which is tapped with the pen. Data may be synchronized between the PDA and a desktop computer through a cable or wireless transmissions. From step 515, the subroutine 230 continues to step 520 and returns to subroutine 240 of FIG. 2.

End-use-device Converts the E-mails and Displays the Image

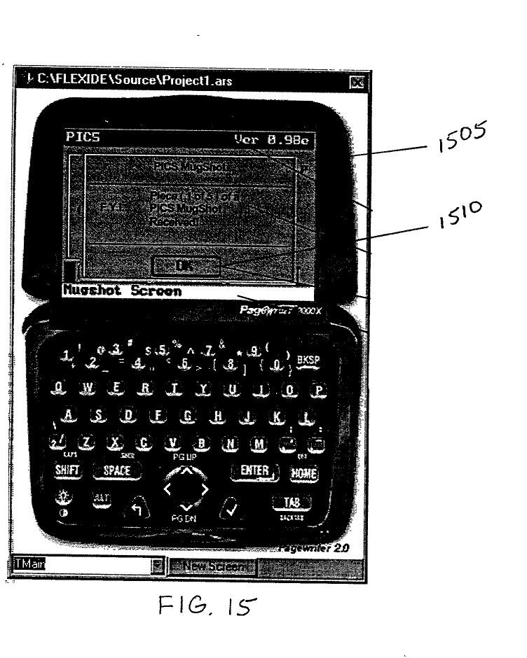

Turning now to FIG. 6, describing the exemplary subroutine 240 from FIG. 6 is further described where the end-use-device 188 converts the e-mails into the image and displays the image. In an example, referring to FIG. 14, a Motorola PAGEWRITER 2000X 1405 is displayed. In the embodiment, the PAGEWRITER 2000X 1405 is employed as the end-use-device 188. Those skilled in the art, however, will appreciate that other end-use-devices may be used including, but not limited to, the devices discussed with respect to step 520 of subroutine 230. The PAGEWRITER 2000X 1405 allows end-use-device users to send messages back and forth to each other. In addition, it can send and receive e-mail and faxes and can be programmed to retrieve information from the Internet. This device comprises a keyboard 1410 and a display 1415. The dimensions of the PAGEWRITER 2000X 1405 are 3.75″×2.85″×1.2″and it weighs 6.7 oz. The memory comprises 4 MB of flash memory and 512 kB of RAM for a total of 4.5 MB of memory. The display 1415 is 9 lines by 27 characters with 240×160 pixels. It is power by a NiMH rechargeable battery. Additional information on the PAGEWRITER 2000X 1405 can be obtained from Motorola.

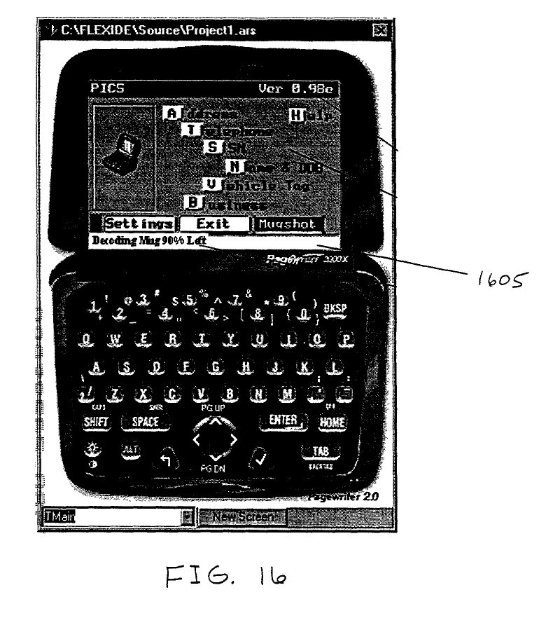

Subroutine 240 begins at starting block 605 and advances to step 610 where the e-mails addressed to the end-use-device 188 are received. FIG. 15 shows an incoming image received prompt 1505 that is displayed once for each e-mail received. The user clicks on the OK button 1510 to advance to the next step. After the end-use-device user 190 clicks the OK button 1510 on the incoming image received prompt 1505, subroutine 240 advances from step 610 to step 620 where the plurality of e-mails are reconstructed into the image data 115. At this step, a programming module within the end-use-device 188 receives the plurality of e-mails which contain blocks of ASCII characters. Using the headers contained in the e-mails, the programming module joins or, more specifically stated, concatenates the data contained in the plurality of e-mails in the order specified in the header as previously discussed. The image details 120 likewise are extracted from the plurality of e-mails.

From step 620, subroutine 240 continues to step 630 where the image data 115 is converted to a displayable format. At this step, a programming module within the end-use-device 188 receives the image data 115. This module decodes the ASCII image data within the image data 115 into a binary image that can be displayed on the end-use-device 188. In the present embodiment, the programming module is a UUdecode algorithm specifically designed for the end-use-device 188. During this process, the decoding message bar 1605 of FIG. 16 informs the end-use-device user 190 of a percentage of the image left to reconstruct.

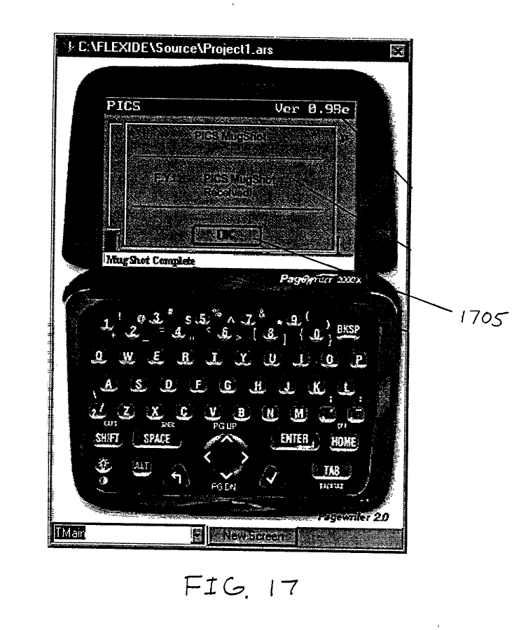

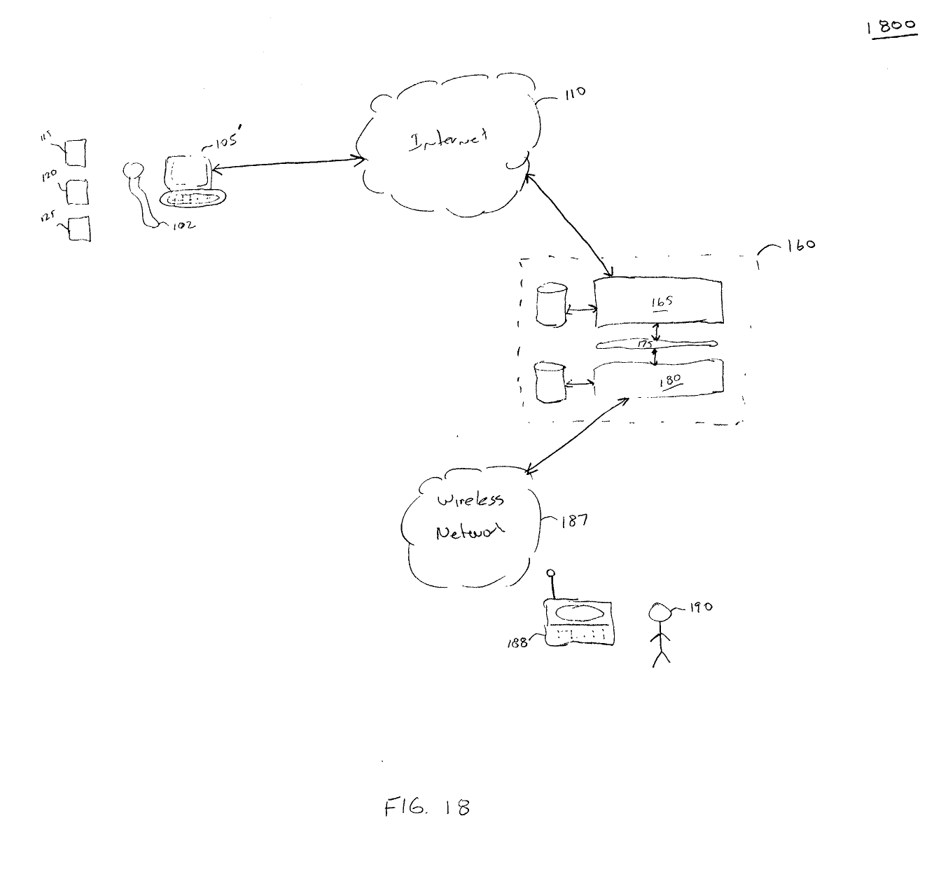

Once the image is converted to a displayable format in step 630, the subroutine advances to step 640 where a prompt is displayed informing the end-use-device user 190 that the image is received and prompting the end-use-device user 190 to click on the OK button 1705 to display the image as show in FIG. 17. After the OK button 1705 is clicked, the subroutine advances to step 650 where the image is displayed on the end-use-device 188. Image details 120 may also be displayed. From step 650, the subroutine 240 continues to step 660 and returns to step 250 of FIG. 2.

Alternative Embodiment of the Present Invention

An alternative embodiment of the present invention provides for the sending of data contained in the image data 115 and the image details 120 from a user computer 105′ to an end-use-device 188. Referring now to FIG. 18 and in contrast with the preferred embodiment, the user computer 105′ of this alternative embodiment carries out the functionality of the first server 130 and the user computer 105 of the preferred embodiment. This embodiment of the present invention comprises the user computer 105′ operated by a user 102, a second server 160, a wireless network 187, and an end-use-device 188 designated by the recipient end-use-device data 125 and operated by an end-use-device user 190. The function of the second server 160 is to provide an interface to the wireless network 187.

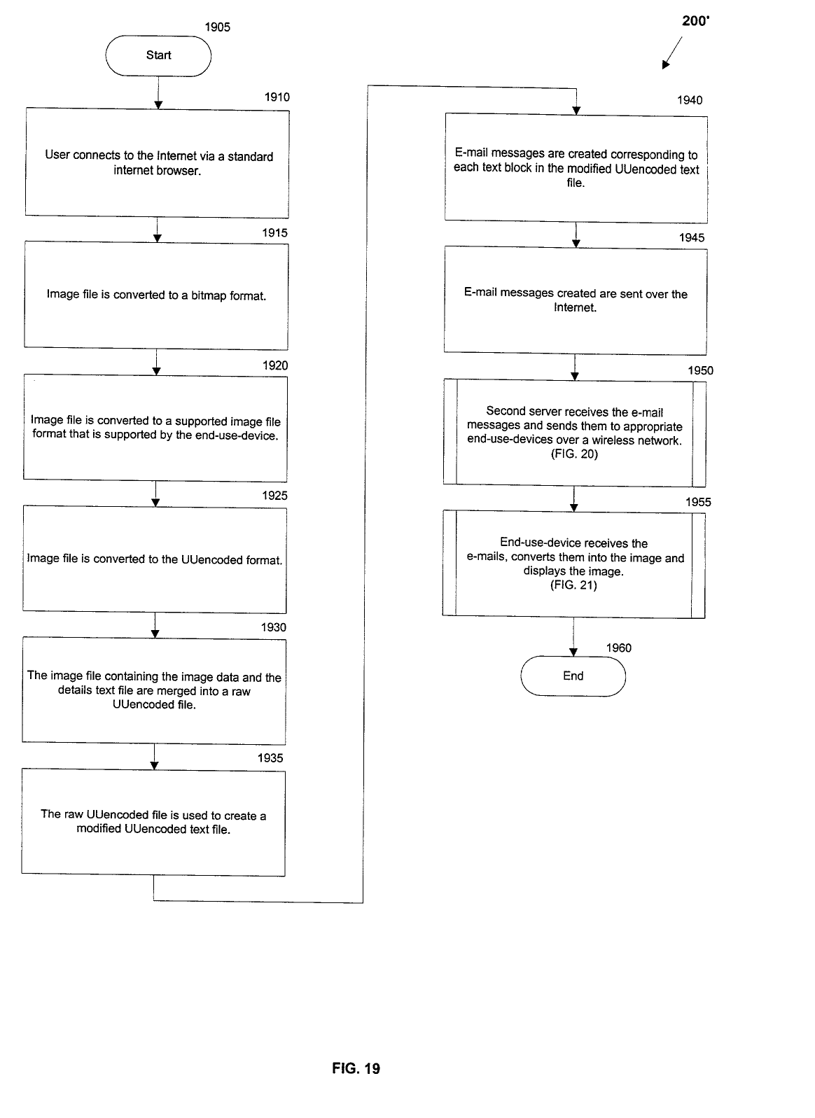

An exemplary method 200′ illustrates how the user 102 converts data contained in the image data 115, image details 120 and recipient end-use-device data 125, and sends the data in multiple e-mails to the second server 160. Turning now to FIG. 19, method 200′ begins at starting block 1905 and advances to step 1910 where the user 102 connects to the internet 110 via a standard internet browser. Preferred methods of the present invention utilize a user computer 105′, as described previously with respect to the preferred embodiment of the invention.

From step 1910, method 200 advances to step 1915 where the image data 115 is typically converted at the user computer 105′ from its original format to an 8-bit grayscale bitmap format. In addition, the image is usually resized to a height of 115 pixels or a max width of 100 pixels and saved in the bitmap format.

From step 1915, method 200′ advances to step 1920 where the image data 115 is converted to a supported image file format that is supported by the end-use-device 188. Similar to the preferred embodiment, if a Motorola PAGEWRITER 2000X pager supplied by Motorola, Inc., of Schaumburg, Ill. is utilized as the end-use-device 188, the “.rob” format may be used. The “.rob” format is a proprietary image format that is supported by the Motorola PAGEWRITER 2000X pager. In this case, image data 115 is converted from the bitmap format to the “.rob” format using an executable file supplied by Motorola, Inc.

From step 1920, method 200′ advances to step 1925 where the image data 115, now in the supported image file format, is converted at the user computer 105′ to the UUencoded format. The traditional UUencode headers and footers are removed from this file. A UUencode utility encodes a file by converting 8-bit characters into 7-bit ASCII text, and a UUdecode utility decodes the file back to the original format at the receiving end.

From step 1925, method 200′ advances to step 1930 where the image data 115 containing the image data and the details text file 1105 of FIG. 11 are merged into a raw UUencoded file 1205 as shown if FIG. 12. This file contains a traditional UUencoded header 1210, traditional UUencoded footer 1215, UUencoded image file data 1220, and details text file data 1225.

After the raw UUencoded file 1205 is created in step 1930, the subroutine continues to step 1935 where the raw UUencoded file 1205 is used to create a modified UUencoded text file 1305 as shown in FIG. 13. Because the end-use-device 188 may be limited to a maximum size file it can receive, the data contained in the raw UUencoded file 1205 is usually divided into blocks as it is placed in the modified UUencoded text file 1305. For example, the file size limit may be 2000 characters. The total number of blocks 1310 need to be sent to the end-use-device 188 is determined and placed in the modified UUencoded text file 1305. Next at this step, the text of the raw UUencoded file 1205 is split into a plurality blocks equal to the total number of blocks 1310 determined previously. In FIG. 13, a typical block 1312 is shown. Prior to the block 1312 is the header 1315 corresponding to the block which follows a separator 1320 indicating the end of the block. Recipient list 1330 indicating the e-mail address of the recipient end-use-devices is derived from the recipient data and placed in the modified UUencoded text file 1305. Pipes are preferably added to the end of each line to ensure that no characters are cut off when the data is transmitted to the end-use-device 188. An exemplary pipe 1325 is shown in FIG. 13.

From step 1935, method 200′ advances to step 1940 where mail messages are created at the user computer 105′ corresponding to each text block in the modified UUencoded text file 1305. The addresses for the each e-mail is obtained from the recipient list 1330 contained in the modified UUencoded text file 1305.

From step 1940, method 200′ advances to step 1945 where the e-mail messages created in step 1940 are sent from the user computer 105′ to the second server 160 via the Internet 110. The e-mails are sent in numerical order with a short delay between each transmission. The header of each text block determines this order. For example, in a series of five blocks, the following header tags are in numerical order: 15, 25, 35, 45, 55, wherein 15 indicates 1 of 5, 25 indicates 2 of 5, and so forth. An exemplary header tag 1335 containing 55 is shown in FIG. 13.

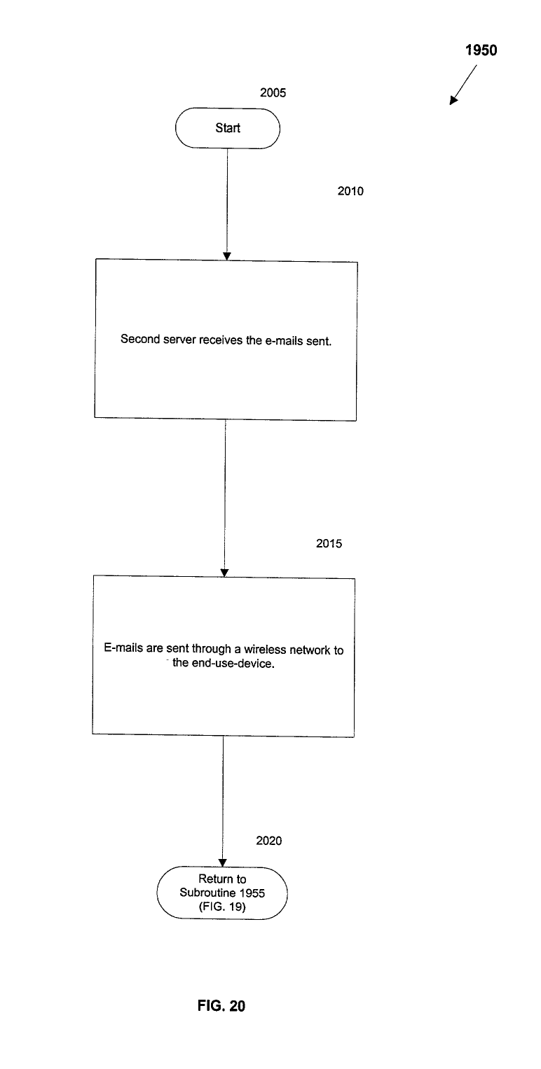

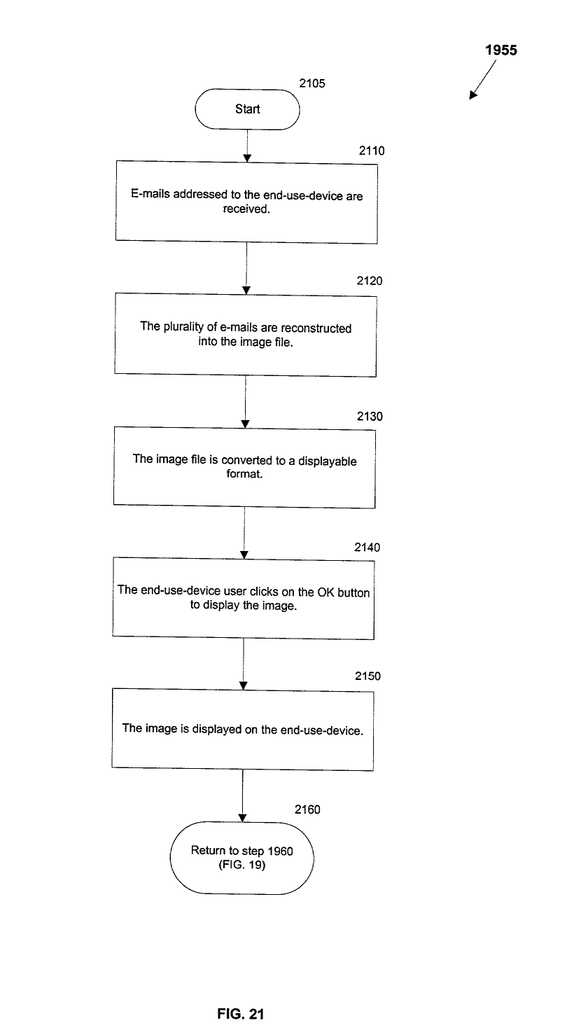

Exemplary method 200′ continues to subroutine 1950, where the second server 160 receives the e-mail messages and sends them to the end-use-device 188 over a wireless network 187. The steps of subroutine 1950 are shown in FIG. 20 and will be described in greater detail below. From subroutine 1950, method 200′ continues to subroutine 1955 where the end-use-device 188 receives the e-mails, converts them into the image and displays the image. The steps of subroutine 1955 are shown in FIG. 21 and will be described in greater detail below. From subroutine 1955, exemplary method 200′ ends at step 1960.

An exemplary subroutine 1950 from FIG. 19 illustrates how the second server 160 receives the e-mail messages and sends them to the end-use-device 188 over a wireless network 187 in FIG. 20. Turning now to FIG. 20, subroutine 1950 begins at starting block 2005 and advances to step 2010 where the second server 160 receives the e-mails previously sent. The second server 160 is operated by a provider of wireless e-mail services. Those skilled in the art will appreciate that many wireless e-mail service providers are available.

Once the second server 160 receives the e-mails, subroutine 1950 advances to step 2015 where the e-mails are in turned sent through a wireless network 187 to the end-use-device 188 corresponding to the addressee of the e-mail. As stated previously, wireless is defined as radio transmission via the airwaves. Those skilled in the art will appreciate that various other communication techniques can be used to provide wireless transmission including, but not limited to, infrared line of sight, cellular, microwave, satellite, packet radio and spread spectrum radio. The end-use-device 188 in this case can be any mobile terminal such as a smart phone, personal digital assistant, intelligent pager, portable computer, hand held computer, or any device capable of receiving wireless data. Wireless data may include but is not limited to paging, text messaging, e-mail, Internet access and other specialized data applications specifically excluding voice transmission. From step 2015, the subroutine 1950 continues to step 2020 and returns to subroutine 1955 of FIG. 19.

The exemplary subroutine 1955 from FIG. 19 is described in more detail below where the end-use-device 188 receives the e-mails, converts them into the image and displays the image. Referring now to FIG. 21, subroutine 1955 begins at starting block 2105 and advances to step 2110 where the e-mails addressed to the end-use-device 188 are received. For example, FIG. 15 shows an incoming image received prompt 1505 that is displayed once for each e-mail received. The user clicks on the OK button 1510 to advance to the next step. After the OK button 1510 is clicked on the incoming image received prompt 1505, subroutine 1955 advances from step 2110 to step 2120 where the plurality of e-mails are reconstructed into the image data 115. At this step, a programming module within the end-use-device 188 receives the plurality of e-mails which containing blocks of ASCII characters. Using the headers contained in the e-mails, the programming module joins or concatenates the data contained in the plurality of e-mails in the order specified in the header as previously discussed with respect to the preferred embodiment. The image details 120 likewise are extracted from the plurality of e-mails.

From step 2120, subroutine 1955 continues to step 2130 where the image data 115 is converted to a displayable format. At this step, a programming module within the end-use-device 188 receives the image data 115. This module decodes the ASCII image data within the image data 115 into a binary image that can be displayed on the end-use-device 188. In the present embodiment, the programming module is a unique UUdecode algorithm specifically designed for the end-use-device 188. During this process, the decoding message bar of FIG. 16 informs the end-use-device user 190 of a percentage of the image left to reconstruct.

Once the image is converted to a displayable format in step 2130, the subroutine advances to step 2140 where a prompt is displayed informing the end-use-device user 190 that the image is received and prompting the end-use-device user 190 to click on the OK button 1705 to display the image as show in FIG. 17. After the OK button 1705 is clicked, the subroutine advances to step 2150 where the image is displayed on the end-use-device 188. Image details 120 may also be displayed. From step 2150, the subroutine 1955 continues to step 2160 and returns to step 1960 of FIG. 19.

In view of the foregoing, it will be appreciated that the present invention provides a method and system for wireless delivery of images. Still, it should be understood that the foregoing relates only to the exemplary embodiments of the present invention, and that numerous changes may be made thereto without departing from the spirit and scope of the invention as defined by the following claims.

We claim:

1. A method for transmitting an image comprising the steps of:
receiving image data in a first file format at a first server;
converting said image data to a plurality of image files in a second file format, each one of said plurality of image files limited to a specified file size;
transferring said plurality of image files to a second server over a first path; and
sending said plurality of image files from said second server to an end-use-device over a second path, said end-use-device not capable of receiving files over said first path, said end-use-device limited to receiving files of a size less than or equal to said specified size.

2. The method of claim 1, further comprising the steps of:
reassembling at said end-use-device said plurality of image files into an end-use-device file and converting said end-use-device file into a file format capable of being displayed on said end-use-device; and
displaying image contained in said end-use-device file on said end-use-device.

3. The method of claim 1, further comprising the step of transferring said image data to said first server over said first path.

4. The method of claim 3, wherein said image data is in said first file format and is transferred to said first server from a user computer.

5. The method of claim 1, wherein said receiving step further comprises receiving image details and recipient end-use-device data.

6. The method of claim 5, wherein said converting step further comprises placing said image details and said recipient end-use-device data into said plurality of image files.

7. The method of claim 6, further comprising the steps of:
reassembling at said end-use-device said plurality of image files into an end-use-device file and converting said end-use-device file into a file format capable of being displayed on said end-use-device; and
displaying image contained in said end-use-device file on said end-use-device and displaying said image details.

8. The method of claim 6, wherein said end-use-device is designated by said recipient end-use-device data.

9. The method of claim 1, wherein said converting step further comprises the step of placing a unique header in each file of said plurality of image files, said unique header indicating the total number of files comprising said plurality of image files, and said unique header also indicating the position of each file of said plurality of image files within said image data.

10. The method of claim 2, wherein said reassembling step further comprising the steps of:
reading unique headers from each file of said plurality of image files, said unique headers indicating the total number of files comprising said plurality of image files, and said unique headers also indicating the position of each file of said plurality of image files within said image data; and
constructing said end-use-device file by joining said plurality of image files in an order indicated by said unique headers.

11. The method of claim 1, wherein said specified file size is determined by a maximum file size capable of being received by said end-use-device.

12. The method of claim 1, wherein said first path a wireline network.

13. The method of claim 1, wherein said second path is a wireless network.

14. The method of claim 1, wherein said second file format comprises the UUencoded format.

15. A method for transmitting an image comprising the steps of:
converting at a user computer image data in a first file format to a plurality of image files in a second file format, each one of said plurality of image files limited to a specified file size;
transferring said plurality of image files to a second server over a first path; and
sending said plurality of image files from said second server to an end-use-device over a second path, said end-use-device not capable of receiving files over said first path, said end-use device limited to receiving files of a size less than or equal to said specified size.

16. The method of claim 15, further comprising the steps of:
reassembling at said end-use device said plurality of image files into an end-use-device file and converting said end-use-device file into a file format capable of being displayed on said end-use-device; and
displaying image contained in said end-use-device file on said end-use-device.

17. The method of claim 15, wherein said converting step further comprises placing image details and recipient end-use-device data into said plurality of image files.

18. The method of claim 17, further comprising the step of:
reassembling at said end-use device said plurality of image files into an end-use-device file and converting said end-use-device file into a file format capable of being displayed on said end-use-device; and
displaying image contained in said end-use-device file on said end-use-device and displaying said image details.

19. The method of claim 17, wherein said end-use-device is designated by said recipient end-use-device data.

20. The method of claim 15, wherein said converting step further comprises the step of placing a unique header in each file of said plurality of image files, said unique header indicating the total number of files comprising said plurality of image files, and said unique header also indicating the position of each file of said plurality of image files within said image data.

21. The method of claim 16, wherein said reassembling step further comprising the steps of:
reading unique headers from each file of said plurality of image files and, said unique headers indicating the total number of files comprising said plurality of image files, and said unique headers also indicating the position of each file of said plurality of image files within said image data; and
constructing said end-use-device file by joining said plurality of image files in an order indicated by said unique headers.

22. The method of claim 15, wherein said specified file size is determined by a maximum file size capable of being received by said end-use-device.

23. The method of claim 15 wherein said first path is a wireline network.

24. The method of claim 15 wherein said second path is a wireless network.

25. The method of claim 15, wherein said second file format comprises the UUencoded format.

26. A system for transmitting an image comprising:
a first server configured to receive image data in a first file format and convert said image data to a plurality of image files in a second file format, each one of said plurality of image files limited to a specified file size; and
a second server in communications with the first server via a first path, the second server configured to receive said plurality of image files over a first path and to send said plurality of image files from said second server over a second path.

27. The system of claim 26, further comprising an end-use-device in communications with the second server via the second path, the end-use-device configured to reassemble said plurality of image files into a end-use-device file, to convert said end-use-device file into a file format capable of being displayed on said end-use-device, and to display image contained in said end-use-device file, said end-use-device not capable of receiving files over said first path, said end-use device limited to receiving files of a size less than or equal to said specified size.

28. The system of claim 26 further comprising a user computer configured to send said image data to said first server.

29. The system of claim 28, wherein said image data is sent to said first file server over said first path, said image data in said first file format.

30. The system of claim 26, wherein said first server is further configured to receive image details and recipient end-use-device data.

31. The system of claim 26, wherein said first server is further configured to place said image details and recipient end-use-device data into said plurality of image files.

32. The system of claim 27, wherein said first server is further configured to place said image details and recipient end-use-device data into said plurality of image files, and wherein said end-use-device is further configured to display said image details.

33. The system of claim 27, wherein said first server is further configured to place said image details and recipient end-use-device data into said plurality of image files, and wherein said end-use-device is designated by said recipient end-use-device data.

34. The system of claim 26, wherein said first server is further configured to place a unique header in each file of said plurality of image files, said unique header indicating the total number of files comprising said plurality of image files, and said unique header also indicating the position of each file of said plurality of image files within said image data.

35. The system of claim 27, wherein said end-use-device is further configured to:
read unique headers from each file of said plurality of image files and, said unique headers indicating the total number of files comprising said plurality of image files, and said unique headers also indicating the position of each file of said plurality of image files within said image data; and
construct said end-use-device file by joining said plurality of image files in an order indicated by said unique headers.

36. The system of claim 26, wherein said specified file size is determined by a maximum file size capable of being received by said end-use-device.

37. The system of claim 26, wherein said first path is a wireline network.

38. The system of claim 26, wherein said second path is a wireless network.

39. The system of claim 26, wherein said second file format comprises the UUencoded format.

40. A system for transmitting an image comprising:
a user computer configured to convert image data in a first file format to a plurality of image files in a second file format, each one of said plurality of image files limited to a specified file size;
a second server in communications with the user computer via a first path, the second server configured to receive said plurality of image files over a first path and to send said plurality of image files from said second server over a second path.

41. The system of claim 40, further comprising an end-use-device in communications with the second server via the second path, the end-use-device configured to reassemble said plurality of image files into a end-use-device file, to convert said end-use-device file into a file format capable of being displayed on said end-use-device, and to display image contained in said end-use-device file, said end-use-device not capable of receiving files over said first path, said end-use device limited to receiving files of a size less than or equal to said specified size

42. The system of claim 40, wherein said user computer is further configured to place image details and recipient end-use-device data into said plurality of image files.

43. The system of claim 41, wherein said user computer is further configured to place image details and recipient end-use-device data into said plurality of image files.

44. The system of claim 41, wherein said end-use-device is further configured to display said image details.

45. The system of claim 41, wherein said end-use-device is designated by said recipient end-use-device data.

46. The system of claim 40, wherein said user computer is further configured to place a unique header in each file of said plurality of image files, said unique header indicating the total number of files comprising said plurality of image files, and said unique header also indicating the position of each file of said plurality of image files within said image data.

47. The system of claim 41, wherein said end-use-device is further configured to:
read unique headers from each file of said plurality of image files and, said unique headers indicating the total number of files comprising said plurality of image files, and said unique headers also indicating the position of each file of said plurality of image files within said image data; and
construct said end-use-device file by joining said plurality of image files in an order indicated by said unique headers.

48. The system of claim 41, wherein said specified file size is determined by a maximum file size capable of being received by said end-use-device.

49. The system of claim 40 wherein said first path is a wireline network.

50. The system of claim 40 wherein said second path is a wireless network.

51. The system of claim 40 wherein said second file format comprises the UUencoded format.
